(19) United States
(12) Patent Application Publication
(10) Pub. No.: US 2018/0326445 A1
(43) Pub. Date: Nov. 15, 2018

(54) ULTRASONIC HUMIDIFIER WITH A CENTRAL ATOMIZING TUBE

(71) Applicant: Zhijing Wang, Boxborough, MA (US)

(72) Inventor: Zhijing Wang, Boxborough, MA (US)

(21) Appl. No.: 15/593,224

(22) Filed: May 11, 2017

(51) Int. Cl. B05B 17/06; F24F 6/12; B05B 7/00

(52) U.S. Cl. CPC B05B 17/0615; B05B 17/0653; B05B 7/0012; F24F 6/12

(57) ABSTRACT

An ultrasonic humidifier is comprised of an oscillating transducer which can emit ultrasonic waves to the water above it, an open water container which maintain the water level above the transducer, a central atomizing tube, which separates the central vibrating water column from the water around it, on the water surface to certain distance below, and a guide mechanism for maintaining a corresponding position between the center atomizing tube and the transducer. The central atomizing tube needs to keep its centerline coincide with the centerline of the oscillating water column generated by the transducer. The upper end of the central atomizing tube is flush with the water surface, so that the mist generating performance is kept basically stable regardless changing height of the water level. The central atomizing tube may be fitted with an end face or side structure to cooperate with the guide mechanism or other mechanism to achieve the above functional and performance requirements. An ultrasonic humidifier with a central atomizing tube can have increased mist performance by adding a separation tube, which separates a water column from surrounding water.

### FIELD OF THE INVENTION

The invention relates to an ultrasonic humidifier with a central atomization tube, which is used to keep humidifier mist performance stable regardless water level.

### BACKGROUND OF THE INVENTION

Ultrasonic humidifiers generally have a transducer that oscillates the water, a water reservoir with a fixed water level, and a water tank with a closed top end. The outlet of the tank is flush with the water at the bottom of the tank, and the vacuum in the tank keeps the water from running out. When the water level drops during use, the air gets into the tank from the tank outlet. This design achieves a controlled discharge of water, so that the water surface is highly stable. This design is based on maintaining the same height of the water level, in order to make the humidifier generate the mist normally and keep the mist amount stable. If the height of the water increases, due to the transducer's oscillation energy is limited, the transducer cannot make a large amount of water above to produce considerable amplitude. So the humidifier cannot effectively produce water mist, greatly reducing the misting effect and the amount of mist. This conventional humidifier with top sealed water tank usually has a small water release outlet. Therefore the water tank is difficult to clean, its internal is easy to produce mold, bacteria and cause other issues. The use the conventional humidifiers are of inconvenient and unsanitary. In addition the design is also complex with high manufacturing costs.

In recent years, there have been open-top container designs or top fill water tanks for humidifiers. Such a humidifier can add water directly from the top of the container. The container is designed to be open, easy to use and clean. It provides convenience for users. For such ultrasonic humidifier, in order to maintain the above-mentioned stable water level, it uses an additional pump. Due to the pump, the reliability and service life of the humidifiers are greatly affected. It also increases noise. The additional pump also increases the cost.

Therefore, it is desired to have a new technology or a simple design of ultrasonic humidifier, which can generate stable mist and work at different water levels. A humidifier has good reliability, easy to clean and easy to use with feature like top fill tank.

### SUMMARY OF THE INVENTION

The purpose of this invention is to overcome the technical shortcomings of the existing ultrasonic humidifier with top fill water tank, and to provide an ultrasonic humidifier which is simple to use, easy to clean, has good reliability and misting performance.

The invention is realized by the following technical and design scheme. An ultrasonic humidifier with a central atomizing tube is characterized in that it comprises an oscillating transducer which can cause ultrasonic vibration to the water above it, a container or a water tank which hold the water above the transducer, a central atomizing tube floating on the water surface and extend to certain distance below the water surface and which separates central vibrating water column from the peripheral water, and a guide mechanism for maintaining the corresponding position of the central atomizing tube to the oscillating transducer surface. The key point of the technology is to make the central atomization tube, when the water is deeper than the length of tube, always keep its top end basically flush with the water surface, and to maintain the center line of central atomization tube coincide with the center line of the oscillating water column. So that the oscillating water column in the central atomization tube can effectively oscillate and produce water mist. The water mists flow out from the top of the central atomization tube. Thereby maintaining a substantially constant amount of mist at different water level conditions.

The central atomization tube center hole must be open. Both ends of the central atomizing tube and its sides may be provided with other mechanisms to maintain the central atomizing tube floating on the surface of the water or effectively moving up and down with the water surface in the guide mechanism and maintaining the center line of the central atomizing tube coinciding with the center line of the oscillating water column. Central atomization tube structure designs can have a variety of types.

### BRIEF DESCRIPTION OF THE DRAWINGS

FIG. 1 shows a schematic cross-sectional view of an ultrasonic humidifier with a central atomizing tube in an operating state.

FIG. 2 shows a schematic illustration of the cross-section of the central atomizing tube working with the oscillating water column

FIG. 3 shows a schematic illustration of a central atomizing tube that can be used.

FIG. 4 shows another schematic view of the structure of a central atomizing tube that can be used.

FIG. 5 shows third schematic view of the structure of a central atomizing tube that can be used.

FIG. 6 shows a schematic cross-sectional view showing an example of a central atomizing tube guide mechanism in an operating state of an ultrasonic humidifier with a central atomizing tube.

FIG. 7 shows a schematic cross-sectional view showing an example of another central atomizing tube and a guide mechanism in the working state of an ultrasonic humidifier with a central atomizing tube.

FIG. 8 shows a schematic view of a cross-sectional structure of an ultrasonic humidifier with a central atomizing tube and a separation ring for bottom part of vibrating water column in an operating state.

### DETAILED DESCRIPTION OF THE PREFERRED EMBODIMENTS

The invention will be described further below with reference to the accompanying drawings.

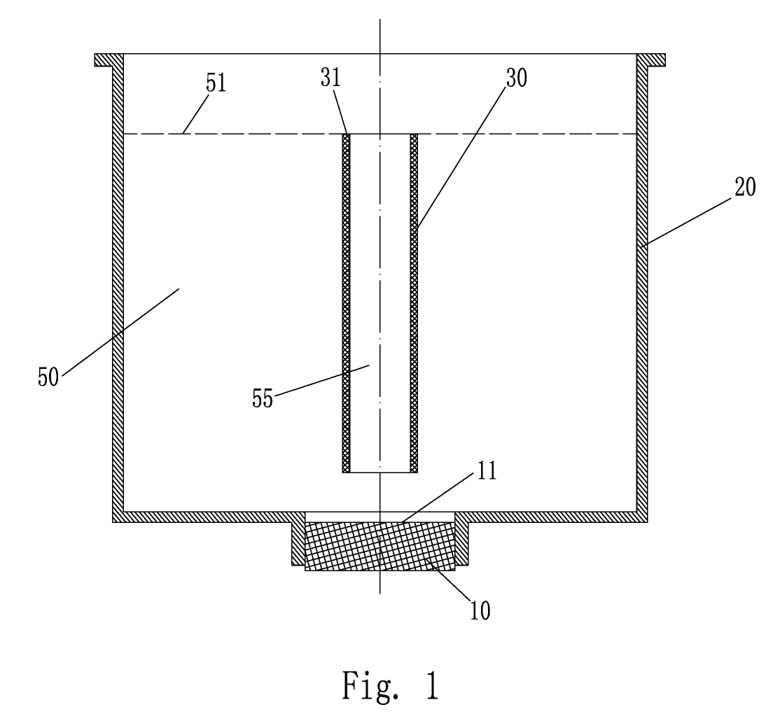

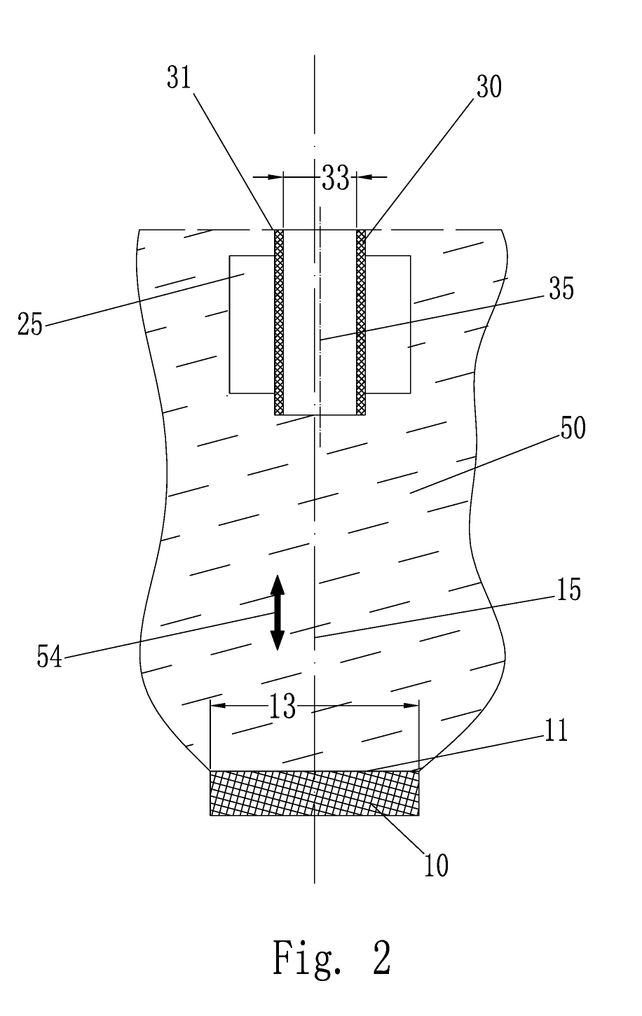

The ultrasonic humidifier with a central atomizing tube as shown in FIGS. 1 to 2 includes an oscillating transducer 10 which can cause ultrasonic vibration of the water 55 above it, an open top water tank 20 for maintaining the water 50 above the transducer, and a central atomizing tube 30 separating the central oscillating water column 55 from the peripheral water 50 from water surface to a certain distance below. The vibrating surface 11 of the ultrasonic oscillating transducer 10 can vibrate in a direction perpendicular to its surface, causing the water above the transducer to vibrate in the direction 54 perpendicular to the transducer surface 11. The central atomizing tube 30 is rigid body. Its function is to isolate the central oscillating water column 55 from the peripheral water 50 and the oscillation of the central oscillating water column 55 is not or less affected by the surrounding water 50. The loss transmission oscillating energy caused by the oscillating transducer is reduced along the central oscillating water column so that the oscillating water column at the upper end can oscillate effectively to generate water mists. Water mists flow out from the opening of the central atomizing tube. According to the central atomizing tube function, the ideal central atom tube design extends from the surface of the water to the proximity of the transducer surface 11. This will minimize the loss of energy to surrounding water.

FIG. 2 shows two additional conditions for the central atom tube to work effectively. First, the centerline 35 of the central atomizing tube is always coincident with the centerline 15 of the vibrating water column regardless of the water level. So that the central atomizing tube 30 can effectively separate the central oscillating water column 55 and the surrounding water 50. So the water column can be vibrated and atomized with little or no influence of the surrounding water. Second, the upper surface 31 of the central atomizing tube is always flush with the water surface 51 regardless of the level of the water. The upper surface 31 of the central atomizing tube cannot protrude out too much beyond the water surface or submerge too much below the water surface. Only in such condition mists can be generated normally and flow out from the upper surface 31 of the central atomizing tube 30. Thereby achieving a misting effect at a high water level.

FIG. 2 further illustrates that the amount of mists also depends on the equivalent size of the sensor vibrating surface 11 and the central atomizing tube inner diameter dimension 33. Usually the ultrasonic atomization sensor is round, in which case the optimum cross section of the central atomizing tube is also circular. The equivalent vibration dimension 13 (denoted by D) of the sensor vibration surface 11 and the central atomizing tube inner diameter dimension 33 (denoted by d) have the following relationship,

0.10D≤d≤D

Further it can be defined as following

0.25D≤d≤0.80D

Optimized the central atomizing tube diameter 33 is usually about half the size of the circular transducer's vibration surface size of 13. The optimum atomizing tube diameter for different transducer operating and water level conditions can be experimentally or/and calculated.

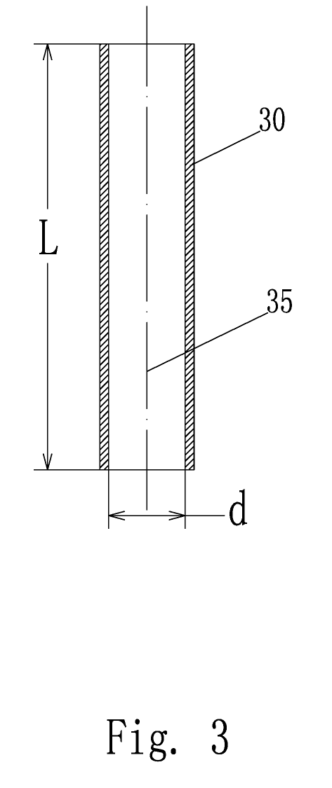

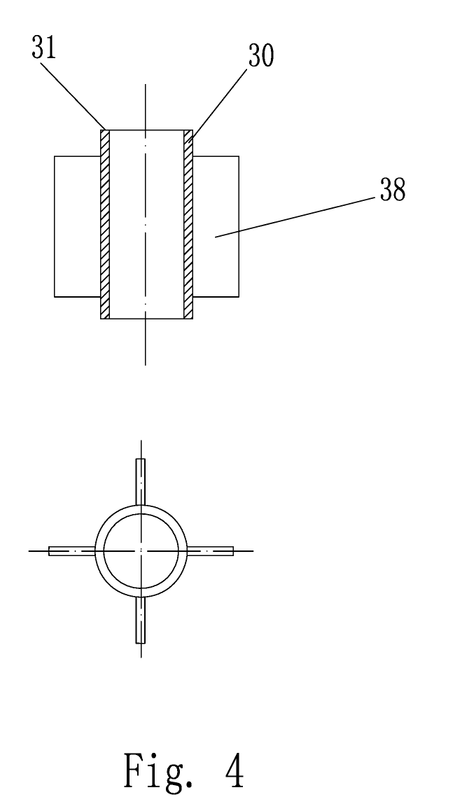

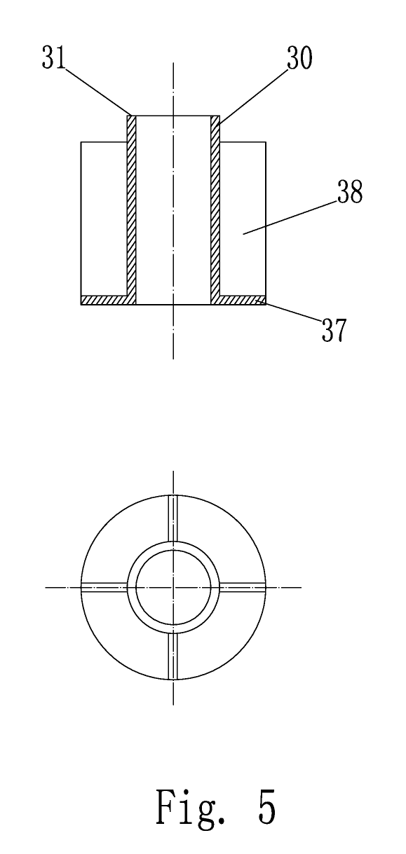

FIG. 3-FIG. 5 shows the designs of several central atomization tubes. The upper and lower sides of the central atomization tube can be designed to add some structures to further ensure rigidity or other requirements. These structures include end faces 37, and peripheral ribs 38, and the likes. The end face may be either a lower end face or an upper end face or both. The ribs can be single or multiple to meet the rigidity of the central atomizing tube as well as the functional and performance needs. Central atomization tube as a whole should be slightly lighter than water and can float in the water. The upper surface 31 of the atomizing tube is roughly flush with the water surface 51 in order to ensure the working condition.

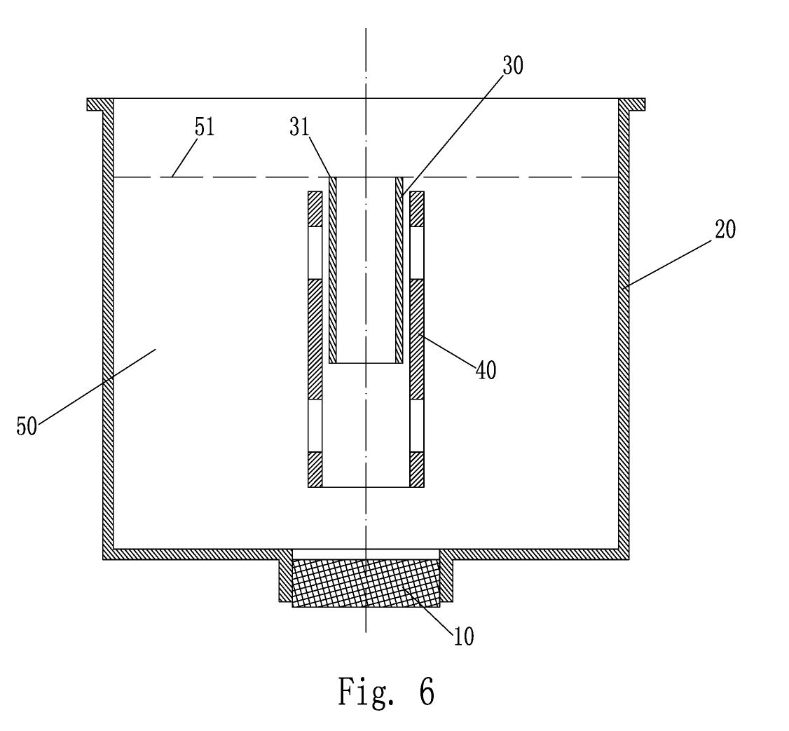

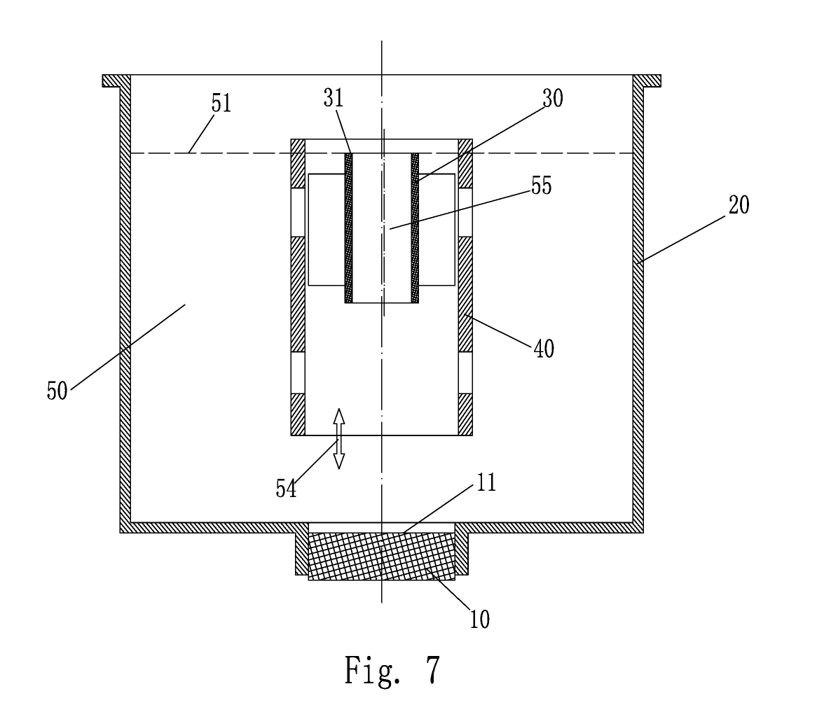

The ultrasonic humidifier with a central atomizing tube as shown in FIG. 6 to FIG. 7 includes an oscillation transducer 10 which can ultrasonically vibrate water above it, a top open water tank 20 for containing above the transducer, a central atomizing tube 30 separating the central oscillating water column 55 from the peripheral water 50 from water surface to certain distance below, and a guide mechanism 40 for maintaining the central atomizing tube 30 to a position corresponding to the oscillating transducer 10. The function of the guide mechanism 40 is, in operating state, to maintain the centerline 35 of the central atomizing tube is always coincident with the center line 15 of the vibrating water column regardless of the level of the water. In most cases the actual application of the central atomization tube can not be too long. When the water surface decreases, the longer central atomization tube will be exposed at the top, so that water mist cannot be effectively ejected. Therefore the amount of mist is greatly reduced or even no mist at all. In order to achieve a humidifier to work at different water levels and have a good misting performance, the length of the central atomization tube (denoted by L) has certain requirement, usually meet,

5 mm≤L≤70 mm

Further it can be defined as following

15 mm≤L≤50 mm

Ultrasonic humidifiers are optimized for the length of the central atomizing tube usually in the range of 25-40 mm. The optimum atomization tube length for different transducer operating conditions can be obtained experimentally or/and calculated.

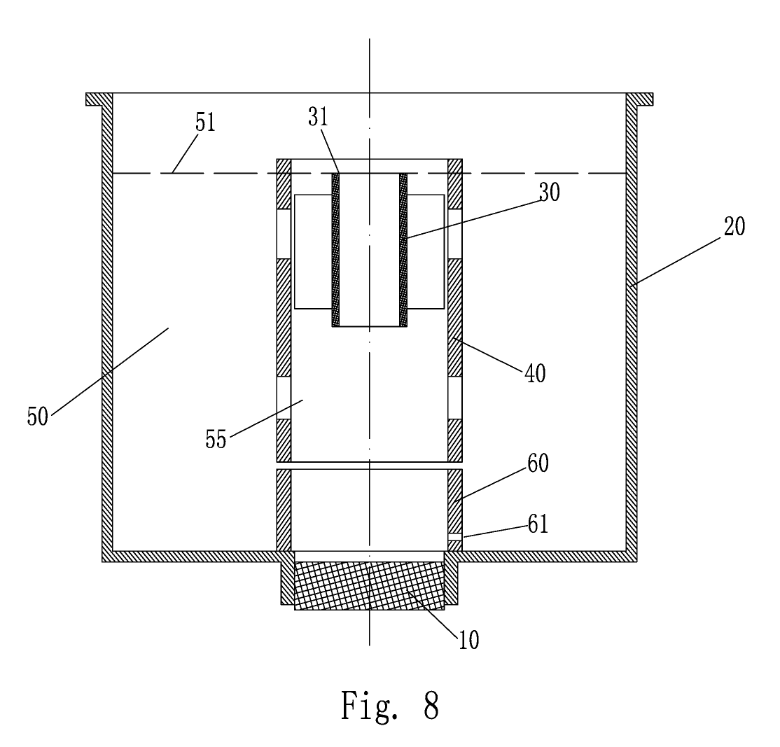

FIG. 8 proposes another embodiment, with a separation ring 60, which surrounds the lower portion of oscillating water column, which further reduces the effect of the external water 50 on the oscillating water column 55. The bottom separation ring is used in conjunction with a central atomizing tube to further enhance the mist effect. The diameter of the bottom separation ring is approximately the same as the outer diameter of the vibration surface of the transducer. The separation ring may be designed as a separate part or part of the guide mechanism. There is a through-hole or through-groove 61 at the bottom of the separation ring to allow free flow of water.

It is important to understand that the description of the embodiments of the top fill humidifiers with central atomization tube of the present invention are illustrative only, and other equivalent arrangements are certainly possible. Therefore, while there have been described the currently preferred embodiments of the invention, Those skilled in the art will recognize that other and further modifications may be made without departing from the spirit and scope of the present invention, and it is intended to claim all modifications and variations as fall within the scope of the appended claims.

What is claimed is:

1. An ultrasonic humidifier with a central atomizing tube comprising an oscillating transducer which can cause ultrasonic vibration to the water above it, a container or a water tank which hold the water above the transducer, a central atomizing tube which separates central vibrating water column from the surrounding water and floats on the water surface and extends to certain distance below the water surface.

2. An ultrasonic humidifier with a central atomizing tube according to claim 1, the centerline of the central atomizing tube coincides with the centerline of the vibrating water column caused by transducer. the upper end of the central atomizing tube is flush with the water surface regardless of the level of the water

3. An ultrasonic humidifier with a central atomizing tube according to claim 1, wherein said central atomizing tube is of a rigid structure. Said central atomizing tube has a cross-sectional shape and a shape of a vibrating surface the same, usually round or nearly round.

4. An ultrasonic humidifier with a central atomizing tube according to claim 1, wherein the equivalent vibration diameter or equivalent dimension D of the vibration surface of the transducer and the inner diameter dimension d of the center atomizing tube have the following relationship,
0.10D≤d≤D
Further it can be defined as following
0.25D≤d≤0.80D.

5. An ultrasonic humidifier with a central atomizing tube according to claim 1, characterized in that said central atomizing tube center must be of open, through hole.

6. An ultrasonic humidifier with a central atomizing tube comprising an oscillating transducer which can cause ultrasonic vibration to the water above it, a container or a water tank which hold the water above the transducer, a central atomizing tube which separates central vibrating water column from the surrounding water and floats on the water surface and extends to certain distance below the water surface, and a guide mechanism for maintaining central atomizing tube a position corresponding to the oscillating transducer.

7. An ultrasonic humidifier with a central atomizing tube according to claim 6, characterized in that said guide mechanism maintains the upper end of the central atomizing tube substantially flush with the water surface and the center line of the central atomizing tube coincide with the center line of the oscillating water column caused by transducer during operation, regardless of the height of water level. The said guide mechanism may be part of the container or an additional part.

8. An ultrasonic humidifier with a central atomizing tube comprising an oscillating transducer which can cause ultrasonic vibration to the water above it, a container or a water tank which hold the water above the transducer, a central atomizing tube which separates central vibrating water column from the surrounding water and floats on the water surface and extends to certain distance below the water surface, a guide mechanism for maintaining central atomizing tube a position corresponding to the oscillating transducer, and an isolation ring in the lower section of the oscillating water column.

9. An ultrasonic humidifier with a central atomizing tube according to claim 8, characterized in that said isolation ring may be part of the said guide mechanism or said container or be an additional part.
